(19) United States
(12) Patent Application Publication
(10) Pub. No.: US 2004/0189612 A1
(43) Pub. Date: Sep. 30, 2004

(54) Touch sensor using light control

(76) Inventors: Frank J. Bottari, Acton, MA (US); Paul J. Richter, Chelmsford, MA (US); Robert S. Moshrefzadeh, Oakdale, MN (US); Elisa M. Cross, Woodbury, MN (US)

Correspondence Address: 3M INNOVATIVE PROPERTIES COMPANY, PO BOX 33427, ST. PAUL, MN, 55133-3427, US

(21) Appl. No.: 10/400,255

(22) Filed: Mar. 27, 2003

(51) Int. Cl. G09G 5/00

(52) U.S. Cl. 345/173

(57) ABSTRACT

Touch sensing methods and systems implement an optical control layer to direct light through a touch sensor. The optical control layer may be arranged as a structural element of the touch sensor. The structural element incorporating optical control functionality may provide a touch surface of the touch sensor. Processes for manufacturing a light control touch sensor involve providing a structural element that incorporates light control and forming an active touch sensing element on the structural element.

The present invention relates generally to touch sensors and, more particularly, to touch sensors with light control.

### BACKGROUND

A touch screen offers a simple, intuitive interface to a computer or other data processing device. Rather than using a keyboard to type in data, a user can transfer information through a touch screen by touching an icon or by writing or drawing on a screen. A number of technologies have been developed for sensing the presence of a touch on a touch screen. Touch sensing technologies include, for example, capacitive, resistive, infrared (IR), surface acoustic wave (SAW), and force-based sensors.

Touch screens are used in a variety of information processing applications. Transparent touch sensors have been particularly useful in interactive systems that also include a computer controlled display. These systems are typically arranged so that information presented on the display can be viewed through the transparent touch screen. The user interacts with the computer system by touching the touch screen at locations indicated by symbols on the display.

The use of touch screens and displays in interactive applications such as information kiosks, automatic teller machines, and point-of-sale terminals presents a range of challenges. Varying light conditions may lead to degraded readability. Degradation of readability may be more intense, for example, in outdoor locations during periods of direct sunlight or during nighttime when light source reflections become problematic. Privacy viewing, i.e., blocking the view of observers other than the user, is also an important consideration for customers making financial or other personal transactions using a publicly located terminal.

### SUMMARY OF THE INVENTION

The present invention is directed to systems and methods for controlling the direction of viewability of light transmitted through a touch sensor. According to one embodiment, a touch sensing method includes providing an optical control layer as a structural element of a touch sensor. The direction of light through the touch sensor is controlled using the optical control function of the structural element. The structural element can be a substrate or superstrate, for example, and can also provide the touch surface of the touch sensor.

In accordance with a further embodiment, a touch sensor includes an optical control layer arranged as a structural element of the touch sensor. The optical control layer is configured to control a direction of light through the touch sensor. The touch sensor further includes an active element coupled to the optical control layer and adapted to sense a touch on the touch sensor.

A further embodiment of the invention involves a process for manufacturing a touch sensor with light control. The process includes providing a structural element of the touch sensor. The structural element is adapted to control the direction of light through the touch sensor. An active element adapted to sense a touch on the touch sensor is formed on the structural element.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIG. 1 is a block diagram of a touch sensing system with light control in accordance with an embodiment of the invention;

FIG. 2 is a flowchart illustrating a touch sensing method in accordance with an embodiment of the invention;

FIG. 3 illustrates the use of a touch screen with light control to enhance the readability of a display in accordance with an embodiment of the invention;

FIG. 4 illustrates the use of a touch screen with light control to provide privacy viewing of a display in accordance with an embodiment of the invention;

FIGS. 5A-C are diagrams of touch sensors with light control arranged to implement resistive, capacitive and near field imaging touch sensing technologies in accordance with an embodiment of the invention;

FIGS. 6A-C are diagrams of touch sensors with light control arranged to implement force, SAW and IR touch sensing technologies in accordance with an embodiment of the invention;

FIG. 7 is a flowchart illustrating a process for manufacturing a touch sensor in accordance with an embodiment of the invention; and

FIG. 8 is a flowchart illustrating a process for manufacturing a capacitive touch sensor in accordance with an embodiment of the invention.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

In the following description of the illustrated embodiments, reference is made to the accompanying drawings which form a part hereof, and in which is shown by way of illustration, various embodiments in which the invention may be practiced. It is to be understood that the embodiments may be utilized and structural changes may be made without departing from the scope of the present invention.

The present invention is directed to methods and systems for controlling light through a touch sensor. Touch sensors with light control have been found to be particularly useful when used in touch sensing systems incorporating computer control displays. Light control touch sensors may be used in combination with displays of various types, including, for example, cathode ray tube (CRT) displays, liquid crystal displays (LCD), light emitting diode (LED) displays, electroluminescent displays (ELD), plasma displays, and static graphics displays to control the direction of the display light. In these systems, the touch sensor is arranged so that the display is viewable through the touch sensor.

Light control touch sensors may be particularly useful in applications where privacy viewing is desired or required, such as a publicly located ATM. In these applications the touch sensor with light control reduces the viewing angle of the display. The line of sight of an unauthorized observer is blocked by the light control touch sensor, allowing the user to conduct a private transaction at a public terminal.

The touch sensor with light control may also be used to enhance the readability of a touch sensing system by blocking off-axis light. For example, light control may be used to improve display readability during periods of direct sunlight or light source reflections. The light control blocks off-axis light while improving the light transmission from the display to the user. Furthermore, reducing off-axis light decreases glare and improves nighttime viewing by decreasing ambient light source reflections. Any suitable light control elements can be used in the present invention. Exemplary light control devices include those disclosed in U.S. Pat. Nos. 4,764,410; 5,147,716; 5,204,160; 5,254,388; and 6,398,370.

The present invention relates to the incorporation of a light control function into a structural element of a touch sensor. For the purposes of this document, a structural element of a touch sensor is an element that provides support for one or more other elements of the touch sensor, and is an element that if removed would result in a touch sensor that no longer functions. For example, a substrate onto which is deposited transparent conductive layer for sensing touch inputs would be considered a structural element. Other instances will be discussed in the context of certain touch technologies. The structural element may or may not provide the touch surface of the touch sensor.

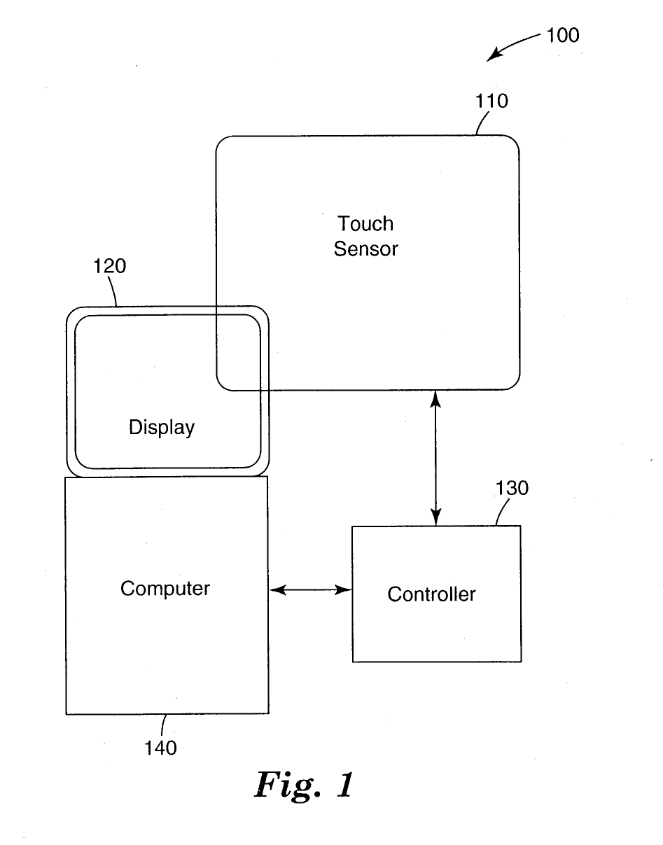

Turning now to FIG. 1, there is shown an embodiment of a touch sensing system 100 using a touch sensor with light control in accordance with an embodiment of the present invention. The touch sensing system 100 shown in FIG. 1 includes a touch sensor 110 that is communicatively coupled to a controller 130. In a typical configuration, the touch sensor 110 is used in combination with a display 120 of a computer system 140 to provide for visual and tactile interaction between a user and the computer system 140. The touch sensor 110 and the display 120 may be arranged so that the display 120 is viewable through the touch sensor 110.

The touch sensor 110 can be implemented as a device separate from, but operative with, the display 120 of the computer system 140. Alternatively, the touch sensor 110 can be implemented as part of a unitary system which includes a display device, such as a plasma, LCD, or other type of display technology amenable to incorporation of the touch sensor 110. It is further understood that the touch sensor 110 may be implemented as a component of a system defined to include only the touch sensor 110 and the controller 130 which, together, can implement a light control touch sensing methodology of the present invention.

In the illustrative configuration shown in FIG. 1, communication between the touch sensor 110 and the computer system 140 is implemented via the controller 130. The controller 130 is typically configured to execute firmware/software that provides for detection of touches applied to the touch sensor 110. The controller 130 may alternatively be arranged as a component of the computer system 140.

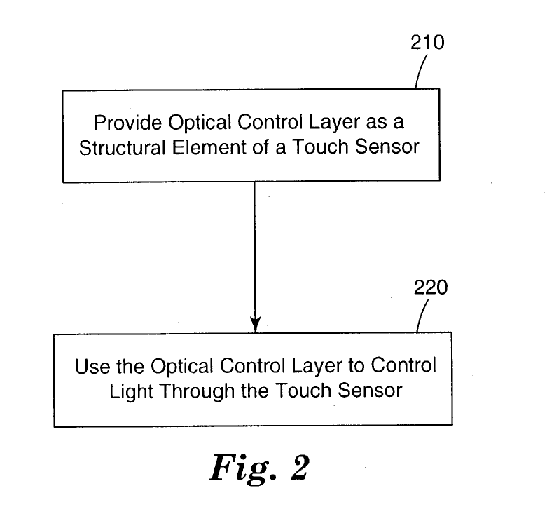

A touch sensing method in accordance with one embodiment of the invention is illustrated in the flowchart of FIG. 2. The method involves providing 210 an optical control layer as a structural element of a touch sensor. The direction of light through the touch sensor is controlled 220 using the optical control layer. In one embodiment, a micro-louvered film is used as the light control layer. The micro-louvered film may be implemented, for example, as a thin layer comprising a series of closely spaced opaque micro-louvers to shield out unwanted light and direct the light of a display through the touch sensor.

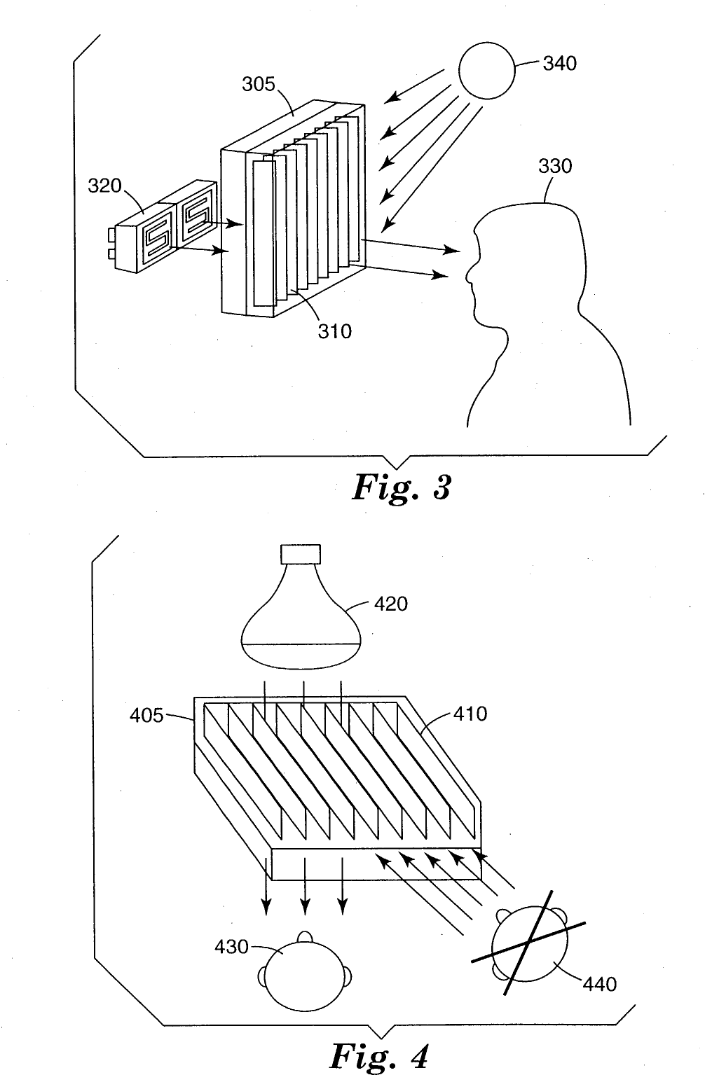

Implementation of light control in accordance with embodiments of the invention is illustrated in the diagrams of FIGS. 3 and 4. FIG. 3 illustrates the use of a touch screen with light control to enhance the readability of a display viewable through the touch sensor. A touch sensor 305 having a light control film 310, such as a micro-louvered film, is arranged between an electro-optical display 320 and a user 330. An ambient light source 340 produces off-axis light that is blocked by the light control film 310. The touch sensor 305 with light control is interposed between the electro-optical display 320 and the user 330. This configuration enhances the readability of the electro-optical display 320 by reducing glare caused by off-axis ambient light source 340.

FIG. 4 illustrates the use of a touch screen with light control to provide privacy viewing of a display. In this implementation, a touch sensor 405 incorporating a light control film 410, e.g., a micro-louvered film, is interposed between a user 430 and a display 420. The presence of the micro-louvered film limits the viewing angle of the display by providing a physical barrier to the light with respect to an unauthorized observer 440 positioned at an angle to the touch sensor and the display. Light from the display 420 passes through the touch sensor's light control film 410 which operates to block the view of the unauthorized observer 440. The user 430 is positioned so that light from the display 420 is directed to the user 430.

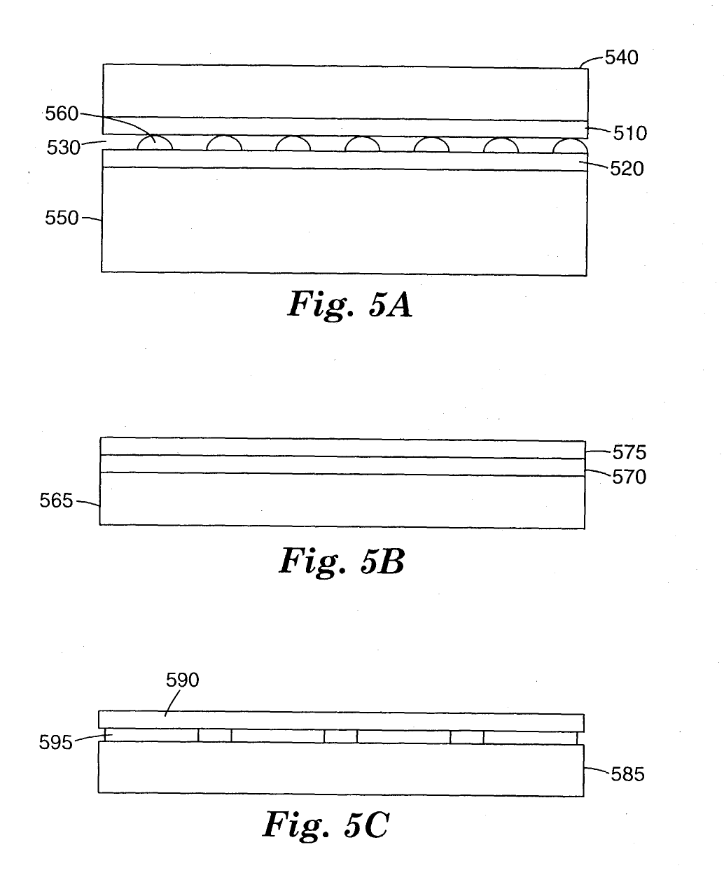

A light control touch sensor in accordance with an embodiment of the invention may employ a resistive touch sensing technology. One configuration of a resistive touch sensor with light control is illustrated in the diagram of FIG. 5. In this implementation, at least one of the structural elements of the resistive touch sensor includes a light control function, for example a micro-louvered light control film.

A resistive touch sensor is energized by the application of a drive signal from a controller to one or more of conductive layers of the resistive touch sensor. A touch applied to the surface of the resistive touch sensor deflects a first flexible, conductive layer, causing the first conductive layer to make contact with a second conductive layer. Contact between the first and second conductive layers causes a change in a sensed electrical signal. The location of the touch is determined as a function of the point of contact between the conductive layers.

A resistive touch sensor with light control, according to the example embodiment of FIG. 5A, includes two transparent conductive layers 510, 520 with a gap 530 interposed between the conductive layers 510, 520. The conductive layers 510, 520 may include a transparent conductive oxide such as indium tin oxide (ITO), antimony tin oxide (ATO), tin oxide (TO), or any other suitable transparent conductive materials, including conductive polymers.

Either (or both) flexible superstrate 540 or substrate 550 can incorporate a light control film so that the light control film forms a structural element of the resistive touch sensor, and in the case of superstrate 540 can also provide the touch surface. For example, superstrate 540 can be provided as a flexible, micro-louvered film that provides a touch surface as well as being the structural element upon which a first conductive layer 510 is deposited. The second conductive layer 520 is disposed on substrate 550, which also forms a structural element of the sensor. The substrate 550 may be formed of any suitable flexible or rigid material, such as glass or plastic, and can also include light control functionality. One or more spacers 560 may be positioned within the gap layer 530 to maintain an appropriate spacing between the conductive layers 510, 520.

Electrical contact to the conductive layers of the touch sensor may be provided by a discrete wire harness (not shown) coupling the touch sensor to a controller (not shown).

FIG. 5B illustrates a touch sensor based on a capacitive touch sensing technology and incorporating light control in accordance with an embodiment of the invention. In this example, a substrate 565 provides the structural support for the capacitive touch sensor.

The substrate 565 supports a conductive layer 570 disposed thereon. A resistor pattern (not shown) may be screen printed or otherwise formed on the conductive layer 570 to linearize the electric field applied by the touch sensor controller (not shown) across the touch sensor surface. A dielectric layer 575 is disposed on the conductive layer. Conductive touch objects can be coupled to the conductive layer 570 through dielectric layer 575 when placed in sufficient proximity to the conductive layer (for example, when contacting the dielectric layer), thereby drawing a current that can be measured to determine the position of the touch object. Additional layers may be applied to the dielectric layer 575 such as protective coatings, antiglare coatings, or the like. Substrate 565 can incorporate a light control film so that the light control film forms a structural element of the sensor. Also, dielectric layer 575 can incorporate a light control film so that the light control film provides the touch surface of the sensor.

FIG. 5C illustrates a further embodiment using a light control film as a structural element or as a touch surface of a projected capacitive touch sensor that incorporates a plurality of conductive objects, such as wires, bars, or traces, arranged in pattern such as a grid or in a series of parallel lines. Without loss of generality, this embodiment is described employing near field imaging (NFI) touch sensing technology.

NFI touch sensors use a series of transparent conductive bars disposed on a non-conductive substrate to sense a touch. Typically, the touch is sensed through a dielectric medium, which may itself be the sensor substrate. The non-conductive substrate may be comprised of glass or plastic, for example, and may be rigid or flexible. If a separate dielectric medium is provided, it can be disposed over the conductor bars on a side opposing the substrate. The dielectric medium can be a coating or a glass or film overlay. The transparent conductor may be formed of a suitable metal oxide, such as ITO or ATO, or a conductive polymer deposited on the substrate. An AC signal applied to the conductive pattern creates an electrostatic field at the surface of the touch sensor. When a finger or other implement contacts the touch screen surface, the electrostatic field is disturbed and a touch is detected. In the example embodiment illustrated in FIG. 5C, substrate 585 provides structural support for the patterned transparent conductive bars 595, and dielectric overlay 590 provides the touch surface through which conductive touch objects are coupled. Either substrate 585 or overlay 590 can incorporate a light control film to control the directional viewability through the touch sensor.

According to an example embodiment of the invention, a touch sensor that employs force technology for detection of the touch location can use a touch surface that incorporates an optical control layer. Signals representing the force of a touch acting on the touch screen are produced by one or more force transducers coupled to the touch surface of the touch sensor. Determination of the touch location involves analyzing the transducer signals.

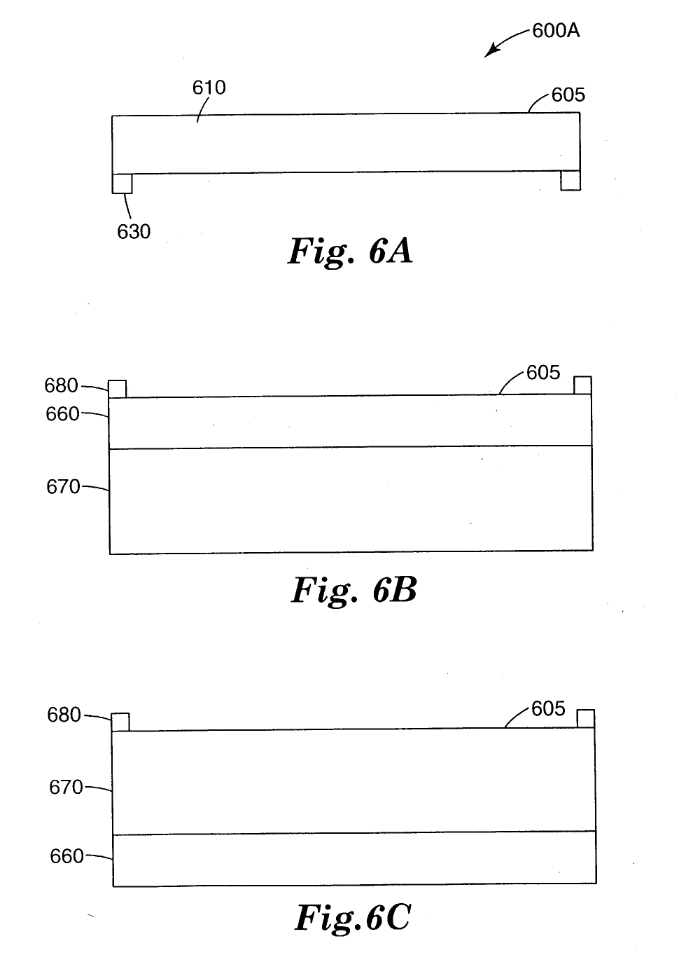

In the configuration illustrated in FIG. 6A, an overlay 610, preferably a rigid overlay, can incorporate a light control film such as a micro-louvered film, for example laminated or otherwise permanently affixed to a rigid or semi-rigid glass or plastic substrate. Alternatively, a rigid or semi-rigid light control element can be used as the overlay 610 without lamination to other layers. Overlay 610 can also form the touch surface 605 of the touch sensor. A force applied to the touch surface 605 passes through to a plurality of force transducers 630 which may be located, for example, at the corners of the overlay 610. The location of the touch is determined by analyzing the signal produced by the force transducers 630. Overlay 610 is a structural element of the sensor 600A.

According to a further embodiment of the invention, touch sensing technologies employing transducers positioned on top of the touch surface, such as with surface acoustic wave (SAW) and infrared (IR) touch sensors, may be used to implement the light control techniques of the present invention.

A SAW touch screen is implemented using a rigid touch surface, such as glass.

Surface acoustic waves are transmitted across the surface of the touch surface by SAW emitters, a series of reflectors, a series of collectors, and SAW detectors. Typically, one set of a SAW emitter, a series of reflectors, a series of collectors, and a SAW detector is used to determine the “x” axis touch location and another set of a SAW emitter, a series of reflectors, a series of collectors, and a SAW detector is used to determine the “y” axis touch location. When a finger or other touch implement is applied to the touch surface, acoustic wave energy can be absorbed. Detector circuitry senses the dip in energy and calculates the touch position.

An infrared touch screen detects touch position by determining beams of light in a grid of such light beams are interrupted by the touch. The grid of light is typically infrared light, and can be produced by an array of light emitting-diodes (LEDs) or by light sources that are waveguided and directed to form a grid. A series of phototransistor detectors, or a collector coupled to a detector, can be arranged to sense the light beams. Controller circuitry directs a sequence of light pulses, scanning the screen with a lattice of light beams just in front of the surface. When a touch is applied to the touch surface by a solid object, the infrared light beams are interrupted. Controller circuitry detects the location at which the light is obstructed.

FIG. 6B illustrates a SAW or infrared touch sensor employing the light control techniques according to one embodiment of the present invention. An optical control layer 660, may be laminated or otherwise affixed on a rigid substrate 670, such as glass, forming a structural element that provides the touch surface 650 of the touch sensor. A touch applied to the touch surface 650 is detected by transducers, such as SAW or IR transducers 680. The touch location is determined by analyzing the signal changes detected by the transducers 680. Another embodiment, illustrated FIG. 6C, shows the optical control layer 660 located on the opposite side of the rigid substrate 670.

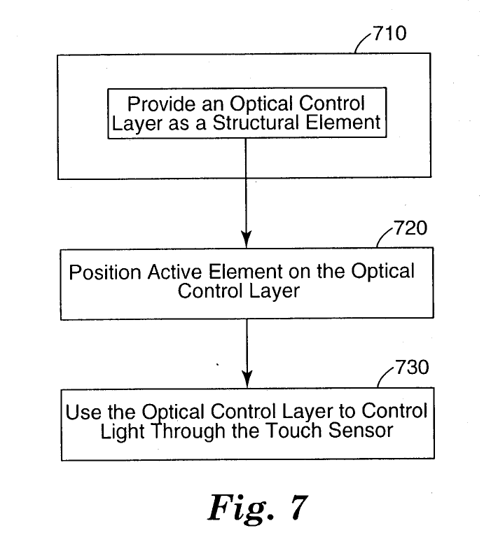

A process for manufacturing a touch sensor employing light control according to embodiments of the invention is illustrated in the flowchart of FIG. 7. In accordance with this embodiment, a substrate incorporating an optical control function is provided 710 as a supporting element 712 or as a touch surface 714 of the touch sensor. An active element of the touch sensor, which may comprise, for example, one or more conductive layers, or various transducers for determining the touch location are positioned 720 on the supporting element. Based on the touch sensing technology employed, additional coatings may be optionally applied to protect the active element of the touch sensor. Light directed through the touch sensor is controlled 730 by the optical control layer.

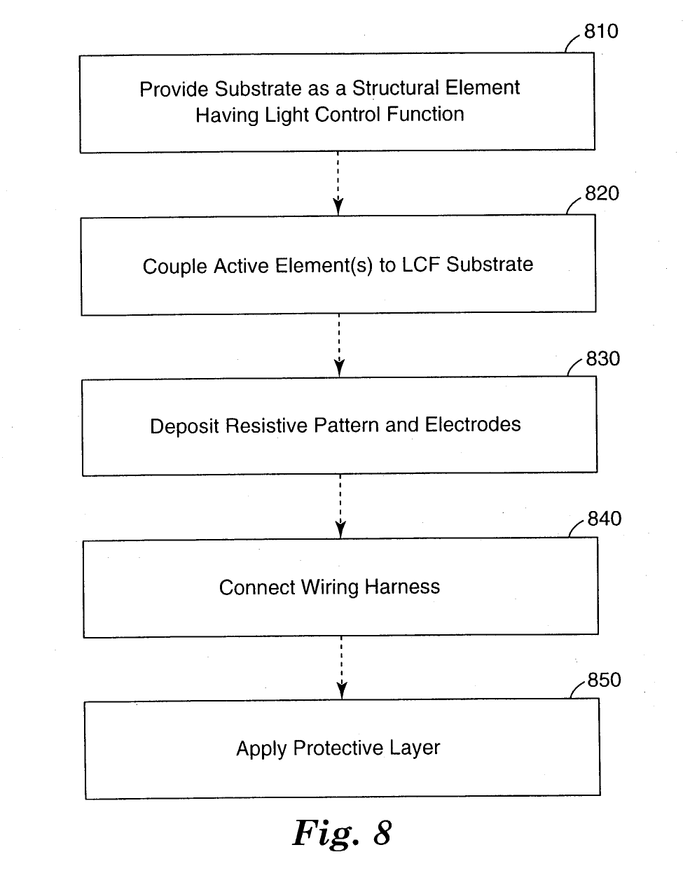

Various processes may be implemented to manufacture touch sensors using the touch sensing technologies described herein, or other known touch sensing techniques. FIG. 8 is a flowchart illustrating an example process for manufacturing a capacitive touch sensor in accordance with an embodiment of the invention. According to this embodiment, a substrate incorporating a light control film (LCF substrate) is provided 810 as a structural element of a touch sensor.

An active element, for example a transparent conductive layer, is coupled 820 to the LCF substrate. One example for the preparation and application of a conductive layer is provided below.

In the case of capacitive touch sensors, for example, electrodes can be formed 830 on the conductive layer to provide connection between the conductive layer of the touch sensor and the controller. The capacitive touch sensor may be enhanced by the application of a resistive pattern to the conductive layer. The resistive pattern is configured to linearize the electric field imposed across the surface of the conductive layer by the controller.

Following formation of the electrodes a wiring harness can be connected 940 to the electrodes. A protective coating may be deposited 950 on the touch sensor.

A more detailed example of a manufacturing process that may be utilized to produce a capacitive touch sensor is provided below. The example embodiment provided below represents one process for manufacturing a light control touch sensor. Those skilled in the art will recognize that manufacture of the light control touch sensor is not limited to the example process provided herein.

A micro-louvered light control film substrate (available from 3M Company under the trade designation LCF-P) was cleaned with de-ionized water.

A conductive polymer coating solution was prepared and then applied to the light control film substrate. The conductive polymer coating solution was prepared by mixing 1287.6 g of an aqueous dispersion of poly(3,4-ethylenedioxythiophene) polystyrene sulphonate (trade designation Baytron P, available from Bayer Corp.), 77.4 g of ethylene glycol, 27 g of 3-glycidoxypropyl trimethoxysilane, 1600.2 g of isopropyl alcohol, and 60 drops (applied from a pipette available under the designation SAMCO 212 pipette) of a fluorosurfactant (trade designation FC-171, 3M company). The mixture was stirred for 24 hours at room temperature then filtered to 5 μm before use. The conductive coating solution was applied to the substrate using a custom precision dip coater set to a withdrawal speed of 0.170 inches per second. The coated substrate was then cured at 85° C. for 6 minutes in a box furnace. A resistive material (available from DuPont under the designation 5089 Membrane Switch Compound) was then screen printed around the perimeter of the coated substrate to form a linearization pattern. The printed substrate was cured at 130° C. for 6 minutes.

A discrete wire electrical harness was connected to each of the four corners of the linearization pattern with conductive epoxy (Circuitworks CW2400) and cured at 120° C. for 6 minutes.

A protective coating solution for the touch sensor was made by mixing 87.5 g of a silicone modified polyacrylate (Silclean 3700 from BYK Chemical), 0.03 g of a 10% solution of dibutyltin dilaurate in propylene glycol methyl ethyl acetate, and 12.47 g resin solution (Desmodur L-75N from Bayer Corporation). This mixture was then diluted with 95 g propylene glycol methyl ethyl acetate. The solution was sprayed onto the touch screen and then cured at 66° C. for 1 hour.

The result was a flexible capacitive touch screen that included a conductive polymer as the signal sensing layer, the conductive polymer coated onto a light control film as the substrate. The light control film substrate allowed for viewing objects through the touch screen at normal and near normal incidences, and blocked viewing of objects through the touch screen at larger viewing angles.

The foregoing description of the various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A touch sensing method, comprising:
providing a structural element of a touch sensor; and
controlling directional viewability of light through the touch sensor using the structural element.

2. The method of claim 1, wherein the structural element comprises a micro-louvered layer.

3. The method of claim 1, wherein the structural element comprises a substrate of the touch sensor.

4. The method of claim 1, wherein the structural element comprises a superstrate of the touch sensor.

5. The method of claim 1, wherein the structural element comprises a touch surface of the touch sensor.

6. The method of claim 1, wherein the touch sensor is a transparent touch sensor.

7. The method of claim 1, wherein the touch sensor is a flexible touch sensor.

8. A touch sensor, comprising:
a structural element of the touch sensor configured to control a viewable range of angles through the touch sensor; and
an active element coupled to the structural element and adapted to sense a touch on the touch sensor.

9. The touch sensor of claim 8, wherein the structural element comprises a micro-louvered layer.

10. The touch sensor of claim 8, wherein the active element comprises one or more conductive layers.

11. The touch sensor of claim 10, wherein the one or more conductive layers comprises a transparent conductive oxide.

12. The touch sensor of claim 10, wherein the one or more conductive layers comprises a conductive polymer.

13. The touch sensor of claim 8, wherein the touch sensor is a capacitive touch sensor.

14. The touch sensor of claim 8, wherein the touch sensor is a resistive touch sensor.

15. The touch sensor of claim 8, further comprising a control system coupled to the touch sensor and configured to determine a touch location on the touch sensor.

16. The touch sensor of claim 8, further comprising a display, configured to display information through the optical control layer.

17. The touch sensor of claim 16, further comprising a processor coupled to the display and adapted to process touch location information and data to be displayed on the display.

18. A touch sensor, comprising:
a structural element comprising an optical control layer for controlling a viewable range of angles through the touch sensor; and
an active element coupled to the optical control layer, the active element adapted to sense a touch on the optical control layer.

19. The sensor of claim 18, wherein the optical control layer comprises a micro-louvered layer.

20. The sensor of claim 18, wherein the touch sensor is a transparent touch sensor.

21. The sensor of claim 18, wherein the active element comprises one or more force touch sensor.

22. The sensor of claim 18, wherein the active element comprises a plurality of conductive sensor bars.

23. The sensor of claim 18, wherein the touch sensor is a surface acoustic wave touch sensor.

24. The sensor of claim 18, wherein the touch sensor is an infrared touch sensor.

25. The touch sensor of claim 18, further comprising a control system coupled to the touch sensor and configured to determine a touch location on the touch sensor.

26. The touch sensor of claim 18, further comprising a display, configured to display information through the optical control layer.

27. The touch sensor of claim 18, further comprising a processor coupled to the display and adapted to process touch location information and data to be displayed on the display.

28. A process for manufacturing a touch sensor, comprising:
providing a structural element of the touch sensor adapted to control the viewing angle of the transparent touch sensor; and
forming an active element coupled to the structural element, the active element adapted to sense a touch on the touch sensor.

29. The process of claim 28, wherein the structural element is a substrate.

30. The process of claim 28, wherein the structural element is a superstrate.

31. The process of claim 28, wherein the structural element comprises a touch surface of the touch sensor.

32. The process of claim 28, wherein the optical control layer is a micro-louvered layer.

33. The process of claim 28, wherein the active element is a conductive layer.

34. The process of claim 33, wherein the conductive layer comprises a conductive polymer.
